(19) United States
(12) Patent Application Publication
(10) Pub. No.: US 2017/0075483 A1
(43) Pub. Date: Mar. 16, 2017

(54) MOBILE TERMINAL

(71) Applicant: Shenzhen Huiding Technology Co., Ltd., Shenzhen (CN)

(72) Inventors: Wei LING, Shenzhen (CN); Gengchun DENG, Shenzhen (CN)

(21) Appl. No.: 15/342,109

(22) Filed: Nov. 2, 2016

Related U.S. Application Data
(63) Continuation of application No. PCT/CN2014/095029, filed on Dec. 25, 2014.

(30) Foreign Application Priority Data
Oct. 27, 2014 (CN) 201410583515.9

(51) Int. Cl. G06F 3/041; G06F 3/044

(52) U.S. Cl. CPC G06F 3/0416; G06F 3/044; G06F 3/0412

(57) ABSTRACT

The present disclosure discloses a mobile terminal, the mobile terminal includes a capacitive touch screen; the capacitive touch screen includes a touch cover plate and a sensing identifying module, the touch cover plate covers the sensing identifying module and has a thickness of 0.40 mm to 2.0 mm. In the embodiments of the present disclosure, the sensing identifying module is integrated into a touch screen, and a full touch panel is used. In this way, the problem of sense difference which is brought by the independently assembled sensing identifying module is solved from the visual and tactile perspectives, the manufacturing procedure is simplified, production and utilization efficiencies are improved, and user's satisfaction is enhanced.

### CROSS REFERENCE TO RELATED APPLICATIONS

The present application is a continuation of international application No. PCT/CN2014/095029, filed on Dec. 25, 2014, which claims priority to Chinese Patent Application No. 201410583515.9, filed on Oct. 27, 2014, both of which are hereby incorporated by reference in its entireties.

### TECHNICAL FIELD

The present disclosure relates to the technical field of mobile terminals, and in particular, relates to a mobile terminal with a touch screen equipped with a sensing identifying module.

### BACKGROUND

At present, a press-type capacitive sensing identifying module of the latest generation of smart handheld devices at home and abroad is embedded into a slot opened on a touch screen such that the sensing identifying module is exposed to a user's fingers for touches. Such design not only increases manufacturing difficulty of the touch screen, but also enhances sense of difference which is brought by the independently assembled sensing identifying module from the visual and tactile perspectives. As a result, the entire structure, appearance and user experience of a device are affected.

### SUMMARY

The present disclosure is implemented by: a mobile terminal, including a capacitive touch screen, wherein the capacitive touch screen includes a touch cover plate and a sensing identifying module, the touch cover plate covers the sensing identifying module and has a thickness of 0.40 mm to 2.0 mm.

### BRIEF DESCRIPTION OF THE DRAWINGS

FIG. 1 is a schematic three-dimensional exploded view of a mobile terminal according to an embodiment of the present disclosure;

FIG. 2 is a schematic section view of the mobile terminal as illustrated in FIG. 1;

FIG. 3 (a) and FIG. 3 (b) are schematic section views of the mobile terminal as illustrated in FIG. 1;

FIG. 4 (a) and FIG. 4 (b) are schematic section views of the mobile terminal as illustrated in FIG. 1;

FIG. 5 is another schematic three-dimensional exploded view of the mobile terminal according to an embodiment of the present disclosure;

FIG. 6 (a) is a schematic section view of the mobile terminal as illustrated in FIG. 5;

FIG. 6 (b) is another schematic section view of the mobile terminal as illustrated in FIG. 5; and

FIG. 6 (c) is another schematic section view of the mobile terminal as illustrated in FIG. 5.

### DETAILED DESCRIPTION

The embodiments of the present disclosure are described in detail hereinafter. Examples of the described embodiments are given in the accompanying drawings, wherein the identical or similar reference numerals constantly denote the identical or similar elements or elements having the identical or similar functions. The specific embodiments described with reference to the attached drawings are all exemplary, and are intended to illustrate and interpret the present disclosure, which shall not be construed as causing limitations to the present disclosure.

In the description of the present disclosure, it should be understood that the terms “thickness”, “upper”, “lower”, “front”, “rear”, “left”, “right”, “vertical”, “horizontal”, “top”, “bottom”, “inner”, “outer” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, it should be noted that unless otherwise specified and defined, the terms “mounted”, “coupled”, “connected” and “fixed” and derivative forms thereof shall be understood in a broad sense, which, for example, may be understood as fixed connection, detachable connection or integral connection; may be understood as mechanical connection or electrical connection, or understood as direct connection, indirect connection via an intermediate medium, or communication between the interiors of two elements or interactions between two elements. Persons of ordinary skill in the art may understand the specific meanings of the above terms in the present disclosure according to the actual circumstances and contexts.

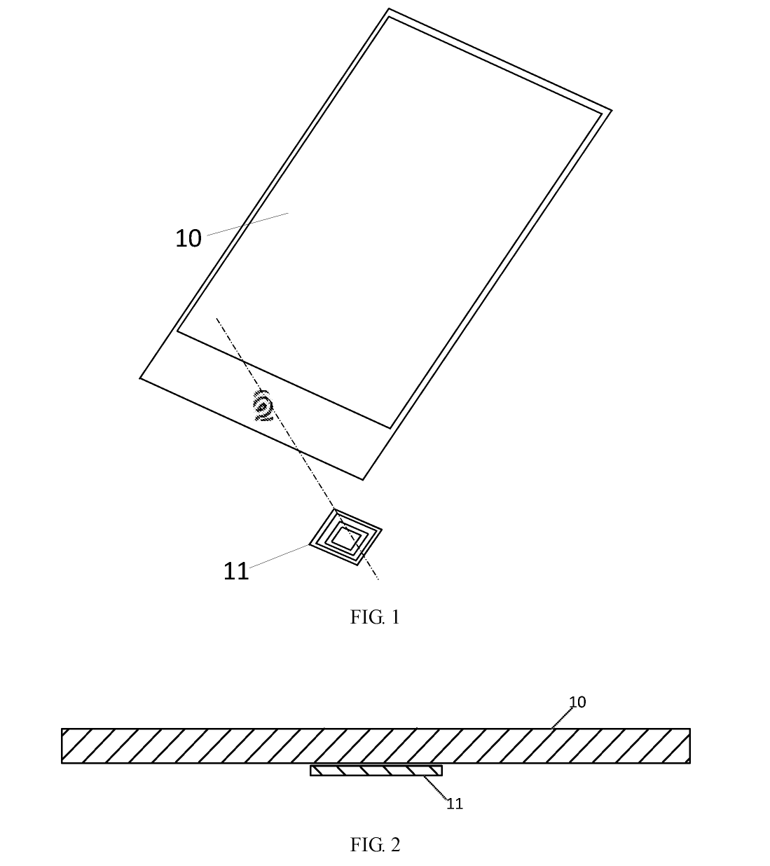

As illustrated in FIG. 1 and FIG. 2, this embodiment discloses a mobile terminal, including a touch screen. The touch screen includes a touch cover plate 10 and a sensing identifying module 11. The touch cover plate 10 covers the sensing identifying module 11. The touch cover plate has a thickness of 0.40 mm to 2.0 mm. Preferably, the sensing identifying module 11 is one or more of a fingerprint identifying module, a heartbeat identifying module and a blood oxygen identifying module.

Several embodiments of the touch cover plate are specifically described hereinafter (a sphere is used as an example in the drawings).

### Embodiment 1

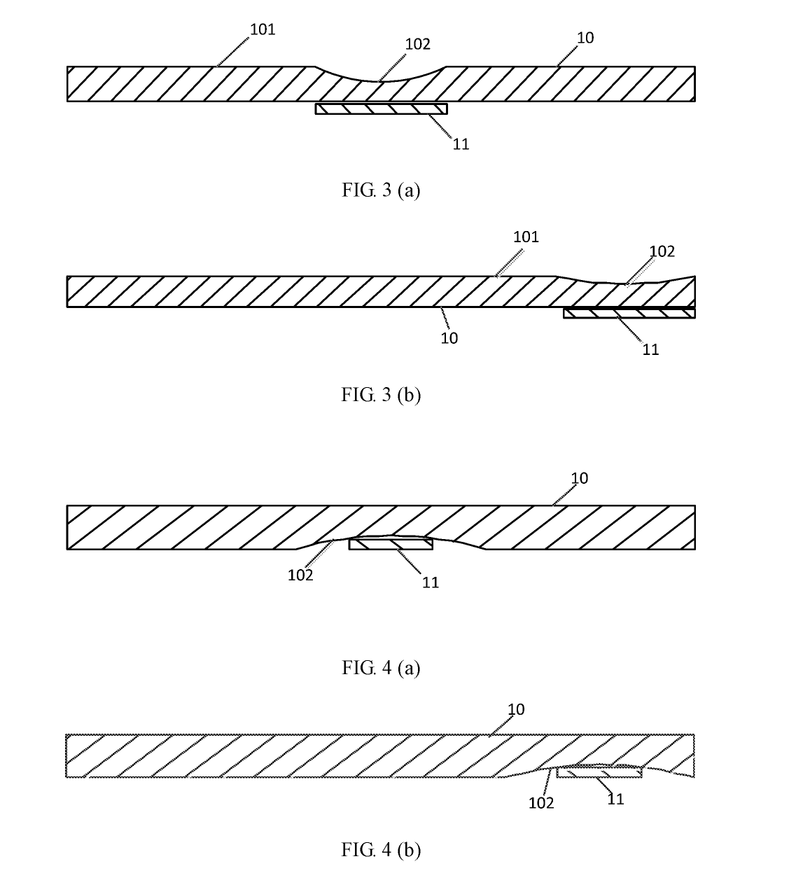

As illustrated in FIG. 3 (a) and FIG. 3 (b), the touch cover plate 10 includes a first part 101 and a second part 102 formed by partially recessing a surface of the touch cover plate, wherein the second part 102 entirely or partially covers the sensing identifying module 11. The second part 102 may have a plane or a spherical surface (only the spherical surface is illustrated in the drawings). Preferably, in this embodiment, the first part has a thickness of 0.40 mm to 2.0 mm, and the second part has a thickness of 0.2 mm to 0.7 mm. Such design is intended to reduce the thickness of the touch cover late 10 covering the sensing identifying module 11, enhance the signal strength, and facilitate data collection by the sensing identifying module 11, and meanwhile indicate the location of the sensing identifying module, thereby facilitating user's operations.

### Embodiment 2

As illustrated in FIG. 4 (a) and FIG. 4 (b), the second part 102 of the touch cover plate 10 may also has a spherical surface formed by partially upwardly recessing a lower surface of the touch cover plate 10. The rest part of the cover plate 10 except the spherical surface part is the first part 101, and the sensing identifying module 11 is partially or entirely received inside the second part 102. In this embodiment, the upper surface of the touch cover plate corresponding to the second part is also partially downwardly recessed to form a plane or a spherical surface (which is not illustrated in the drawings).

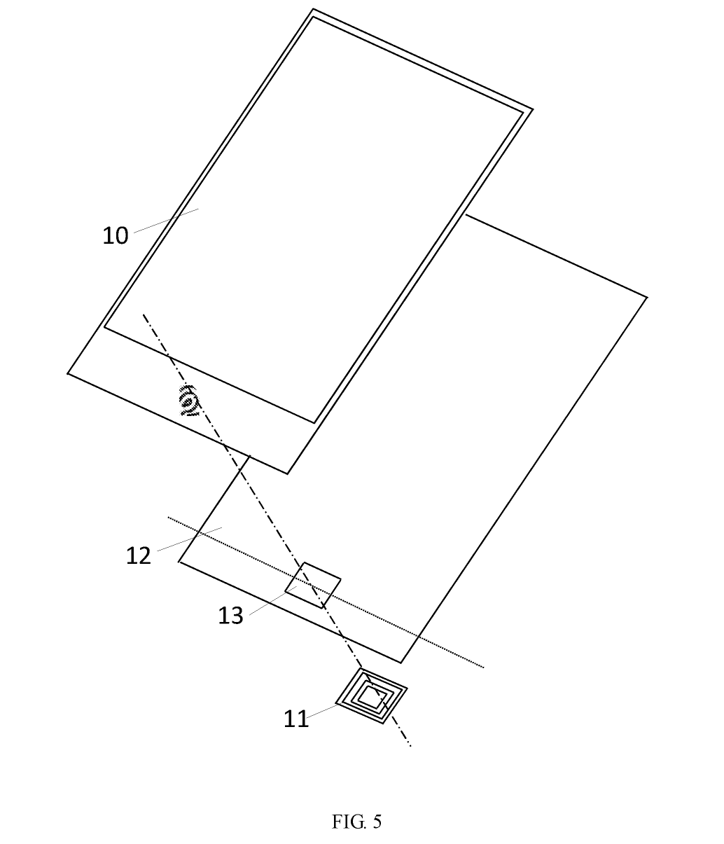

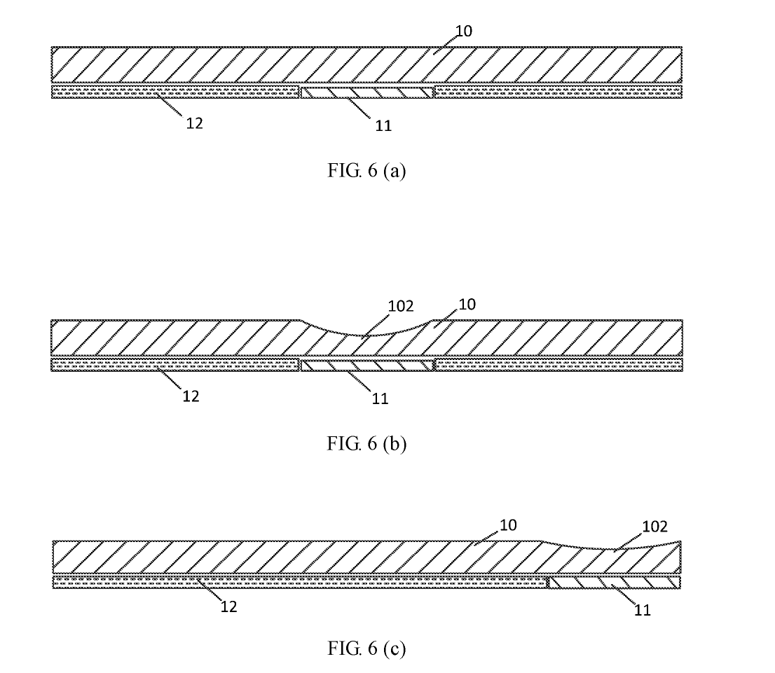

As illustrated in FIG. 5, the touch screen further includes a touch sensor 12, wherein the touch sensor 12 is located beneath the touch cover plate 10. As illustrated in FIG. 6 (a) and FIG. 6 (b), preferably, a through hole 13 may be arranged between an upper surface and a lower surface of the touch sensor 12, and the sensing identifying module 11 may be placed in the through hole and laminated to the touch cover plate 10. Nevertheless, as illustrated in FIG. 6 (c), the sensor 12 may be further placed, side-by-side or in parallel with the sensing identifying module 11, and beneath the touch cover plate 10. A location of the sensing identifying module 11 is not specifically defined. For example, the sensing identifying module 11 may be arranged at a location of a control board close to a physical HOME key or a virtual HOME key.

In the embodiments of the present disclosure, the sensing identifying module 11 is integrated into a touch screen assembly, and a full touch panel is used. In this way, the problem of sense difference which is brought by the independently assembled sensing identifying module 11 is solved from the visual and tactile perspectives, the manufacturing procedure is simplified, production and utilization efficiencies are improved, and user's satisfaction is enhanced.

It should be noted that the mobile terminal herein may be a mobile phone, a tablet computer, or any device having a touch function.

Although the above description illustrates the embodiments of the present disclosure, it can be understood that the embodiments are merely exemplary, and shall not be construed as limitations to the present disclosure. Persons of ordinary skill in the art may derive variations, modifications, and replacements to the above embodiments within the scope of the present disclosure.

### INDUSTRIAL APPLICABILITY

In the present disclosure, the sensing identifying module is integrated into a touch screen. In this way, the problem of sense of difference which is brought by the independently assembled sensing identifying module is solved from the visual and tactile perspectives, the manufacturing procedure is simplified, production and utilization efficiencies are improved, and user's satisfaction is enhanced.

What is claimed is:

1. A mobile terminal, comprising a capacitive touch screen, wherein the capacitive touch screen comprises a touch cover plate and a sensing identifying module, the touch cover plate covers the sensing identifying module and has a thickness of 0.40 mm to 2.0 mm.

2. The mobile terminal according to claim 1, wherein the touch cover plate comprises a first part and a second part formed by partially recessing a surface of the touch cover plate, the second part entirely or partially covers the sensing identifying module, the first part has a thickness of 0.40 mm to 2.0 mm, and the second part has a thickness of 0.2 mm to 0.7 mm.

3. The mobile terminal according to claim 1, wherein the second part has a plane or a spherical surface formed by partially downwardly recessing an upper surface of the touch cover plate.

4. The mobile terminal according to claim 1, wherein the second part has a plane or a spherical surface formed by partially upwardly recessing a lower surface of the touch cover plate, the sensing identifying module is entirely or partially located inside the second part.

5. The mobile terminal according to claim 4, wherein the upper surface of the touch cover plate corresponding to the second part is also partially downwardly recessed to form a plane or a spherical surface.

6. The mobile terminal according to claim 1, wherein the touch screen further comprises a touch sensor, the touch sensor is located beneath the touch cover plate.

7. The mobile terminal according to claim 6, wherein a through hole is arranged between an upper surface and a lower surface of the touch sensor, the sensing identifying module is placed in the through hole and is laminated to the touch cover plate.

8. The mobile terminal according to claim 6, wherein the touch sensor is placed side-by-side with the sensing identifying module and beneath the touch cover plate.

9. The mobile terminal according to claim 1, wherein the sensing identifying module comprises at least one of a fingerprint identifying module, a heartbeat identifying module and a blood oxygen identifying module.

10. An apparatus, comprising a touch screen, the touch screen comprising a touch cover plate, a touch sensor and a sensing identifying module;
wherein the touch sensor and the sensing identifying module are arranged in parallel and beneath the touch cover plate; the touch cover plate has a thickness of 0.40 mm to 2.0 mm, and comprises a first part and a second part having a thickness less than that of the first part; the sensing identifying module is at least partly covered by the second part of the touch cover plate;
wherein the sensing identifying module comprises at least one of a fingerprint identifying module, a heartbeat identifying module and a blood oxygen identifying module.

11. The apparatus according to claim 10, wherein the first part of the touch cover plate has a thickness of 0.40 mm to 2.0 mm, and the second part of the touch cover plate has a thickness of 0.2 mm to 0.7 mm.

12. The apparatus according to claim 11, wherein the second part has a plane or a spherical surface formed by partially downwardly recessing an upper surface of the touch cover plate.

13. The apparatus according to claim 11, wherein the second part has a plane or a spherical surface formed by partially upwardly recessing a lower surface of the touch cover plate.

14. The apparatus according to claim 10, further comprising a physical HOME key or a virtual HOME key, wherein the sensing identifying module is arranged at a location adjacent to the physical HOME key or the virtual HOME key.
